(19) United States
(12) Patent Application Publication
(10) Pub. No.: US 2026/0342616 A1
(43) Pub. Date: Oct. 29, 2026

(54) DEVICE AND METHOD FOR WIRELESS COMMUNICATION

(71) Applicant: SAMSUNG ELECTRONICS CO., LTD., Suwon-si (KR)

(72) Inventors: Hyun-seok LEE, Suwon-si (KR); Mingu KANG, La Jolla, CA (US); Hana KIM, La Jolla, CA (US); Zihan XIA, La Jolla, CA (US); Jiyong YOON, Suwon-si (KR); Jungwon LEE, Suwon-si (KR); Junho LEE, Suwon-si (KR)

(73) Assignee: THE REGENTS OF THE UNIVERSITY OF CALIFORNIA, Oakland, CA (US)

(21) Appl. No.: 19/410,933

(22) Filed: Dec. 5, 2025

Related U.S. Application Data
(60) Provisional application No. 63/795,037, filed on Apr. 25, 2025.

(30) Foreign Application Priority Data
May 15, 2025 (KR) 10-2025-0063537

(51) Int. Cl. H04L 25/02; H04L 5/00; H04W 64/00

(52) U.S. Cl. CPC H04L 25/0202; H04L 5/0048; H04W 64/00

(57) ABSTRACT

An example wireless communication method of a first device includes receiving a pilot signal from the second device via a plurality of antennas, generating channel information by estimating a channel for each of the plurality of antennas based on the pilot signal, calculating a first difference between first channel information corresponding to a first antenna among the plurality of antennas and second channel information corresponding to a second antenna among the plurality of antennas, obtaining first delta channel information by providing input data including the first difference to a trained model, generating second compressed channel information corresponding to the second channel information, based on first compressed channel information corresponding to the first channel information and the first delta channel information, and transmitting compressed channel information including the first compressed channel information and the second compressed channel information to the second device.

### CROSS-REFERENCE TO RELATED APPLICATIONS

This application claims the benefits of Korean Patent Application No. 10-2025-0063537, filed on May 15, 2025, in the Korean Intellectual Property Office, and U.S. Provisional Patent Application No. 63/795,037, filed on Apr. 25, 2025, the disclosures of which are incorporated herein by reference in their entireties.

### BACKGROUND

In a wireless communication system, an accurate identification of the channel state information (CSI) between the transmitting and receiving devices is important. The channel state information enables the transmitting device to adjust its signals according to the channel conditions of the receiving device, thereby improving the efficiency and reliability of transmission. In particular, when a multi-input multi-output (MIMO) or beamforming technique is employed, more accurate channel estimation may be desired, and the receiving device may estimate the channel and report the information to the transmitting device.

### SUMMARY

The present disclosure relates to a wireless communication device for compressing channel estimation information based on artificial intelligence and an operating method thereof.

In some implementations, a wireless communication method includes receiving, by a first device, a pilot signal from a second device via a plurality of antennas, generating, by the first device, channel information by estimating a channel for each antenna of the plurality of antennas based on the pilot signal, calculating, by the first device, a first difference between first channel information and second channel information, the first channel information corresponding to a first antenna among the plurality of antennas, and the second channel information corresponding to a second antenna among the plurality of antennas, obtaining, by the first device, first delta channel information by providing input data to a trained model, the input data including the first difference, generating, by the first device and based on first compressed channel information and the first delta channel information, second compressed channel information, wherein the first compressed channel information corresponds to the first channel information, and the second compressed channel information corresponds to the second channel information and transmitting, by the first device, compressed channel information to the second device, the compressed channel information including the first compressed channel information and the second compressed channel information.

In some implementations, a first device configured to be in communication with a second device includes a plurality of antennas, a transceiver coupled to the plurality of antennas, a memory, and a processor. The processor is configured to generate channel information by estimating a channel of each antenna of the plurality of antennas based on a pilot signal, the pilot signal being received from the second device via the plurality of antennas and the transceiver, calculate a first difference between first channel information and second channel information, the first channel information corresponding to a first antenna among the plurality of antennas, and the second channel information corresponding to a second antenna among the plurality of antennas, obtain first delta channel information by providing input data to a trained model, the input data including the first channel information and the first difference, generate second compressed channel information based on first compressed channel information and the first delta channel information, the second compressed channel information corresponding to the second channel information, and the first compressed channel information corresponding to the first channel information, and transmit compressed channel information to the second device via the transceiver, the compressed channel information including the first compressed channel information and the second compressed channel information.

In some implementations, a method for wireless communication between a first device and a second device, includes receiving, by the second device, compressed channel information from the first device, the first device including a plurality of antennas, calculating, by the second device, a first difference between first compressed channel information and second compressed channel information, the first compressed channel information corresponding to a first antenna among the plurality of antennas, and the second compressed channel information corresponding to a second antenna among the plurality of antennas, obtaining, by the second device, third delta channel information by providing input data and the first difference to a trained model, the third delta channel information corresponding to the second compressed channel information, and the input data including the first compressed channel information, and generating, by the second device, second channel information based on first channel information and the third delta channel information, the second channel information corresponding to the second antenna, and the first channel information corresponding to the first antenna.

### BRIEF DESCRIPTION OF THE DRAWINGS

These and/or other aspects, features, and advantages of the present disclosure will become apparent and more readily appreciated from the following description of example implementations, taken in conjunction with the accompanying drawings.

FIG. 1 illustrates an example of a wireless communication system.

FIG. 2 illustrates an example base station and example user equipment.

FIG. 3 is a diagram of an example of a heat map illustrating channel estimates corresponding to each antenna on a two-dimensional time-delay plane.

FIG. 4 is a flowchart illustrating an example of a wireless communication method.

FIG. 5 is a diagram illustrating an example method of preprocessing channel information.

FIGS. 6A and 6B are diagrams illustrating an example method of processing an input to a trained model.

FIG. 7 is a diagram illustrating an example method of performing a dot product operation.

FIG. 8 is a diagram illustrating an example method of operating user equipment and a base station.

FIG. 9 is a flowchart illustrating an example of a wireless communication method.

FIG. 10 is a flowchart illustrating an example of a wireless communication method.

FIG. 11 is a flowchart illustrating an example of a wireless communication method.

### DETAILED DESCRIPTION

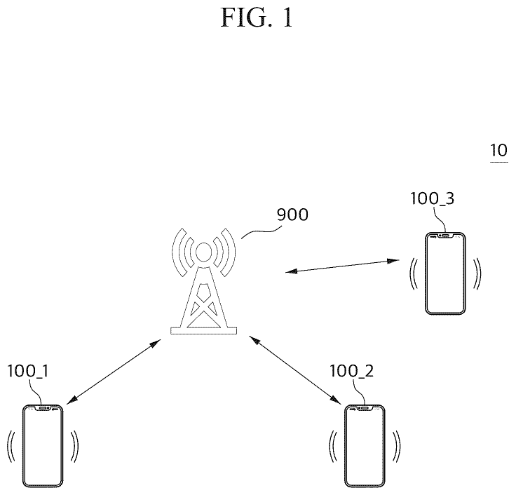

FIG. 1 is a diagram illustrating an example of a wireless communication system 10.

Referring to FIG. 1, the wireless communication system 10 may include a plurality of user equipment 100_1, 100_2, and 100_3 and a base station 900. However, only components related to the example implementation are shown with respect to the system illustrated in FIG. 1. Accordingly, it is to be understood by those skilled in the art that general-purpose components other than the components illustrated in FIG. 1 may also be further included.

In describing implementations of the present disclosure in detail, the wireless communication system 10, which uses a multiple-input multiple-output (MIMO) technique and in which the plurality of user equipment 100_1, 100_2, and 100_3 and the base station 900 communicate with each other via plurality of antennas, will be described primarily. For example, the wireless communication system 10 may also be used in a cellular communication system such as long-term evolution (LTE), LTE-advanced (LTE-A), new radio (NR), wireless broadband (WiBro), and global system for mobile communication (GSM) or a short-range communication system such as Bluetooth and near field communication (NFC), without departing from the scope of the present disclosure.

Various functions described below may be implemented or supported by artificial intelligence (AI) technology or by one or more computer programs. Each program may be configured using computer-readable program code and executed on a computer-readable medium. The terms “application” and “program” may refer to one or more computer programs, software components, instruction sets, procedures, functions, objects, classes, instances, related data, or parts thereof suitable for implementing computer-readable program code. The term “computer-readable program code” refers to all types of computer code, including source code, object code, and executable code. The term “computer-readable medium” refers to all types of medium that may be accessed by a computer such as read-only memory (ROM), random-access memory (RAM), hard disc, compact disc (CD), digital video disc (DVD), or any other type of memory. A “non-transitory” computer-readable medium excludes wired, wireless, optical, or other communication links that transmit temporary electrical or other signals. The non-transitory computer-readable medium may include a medium in which data is stored permanently, or a medium in which data may be stored and overwritten, such as a rewritable optical disc or a deletable memory device.

In various implementations of the present disclosure described below, a hardware-wise approach method will be described as an example. However, since various implementations of the present disclosure include a technique using both hardware and software, the various implementations of the present disclosure do not necessarily exclude a software-based approach method. Additionally, a term referring to control information, a term referring to an entry, a term referring to network entities, a term referring to messages, a term referring to a component of a device, and the like used in the following description are merely examples provided for explanatory convenience. Accordingly, the present disclosure is not limited to the following terms and other terms having the same technical meaning may be used.

In some implementations, the plurality of user equipment 100_1, 100_2, and 100_3 may refer to various devices that are capable of transmitting and receiving data and/or control information by communicating with the base station 900 as a wireless communication device. For example, each of the plurality of user equipment 100_1, 100_2, and 100_3 may be a mobile station (MS), a mobile terminal (MT), a user terminal (UT), a subscribe station (SS), a wireless device, and a mobile device, for example.

In some implementations, the base station 900 may transmit or receive at least one of data and control information by communicating with at least one of the plurality of user equipment 100_1, 100_2, and 100_3 and another base station. For example, the base station 900 may be a Node B, a next generation Node B (gNB), an evolved-Node B (eNB), a base transceiver system (BTS), an access point (AP), and the like.

In some implementations, the plurality of user equipment 100_1, 100_2, and 100_3 may communicate with the base station 900 within a cell coverage of the base station 900. For example, the plurality of user equipment 100_1, 100_2, and 100_3 and the base station 900 may communicate through a downlink channel and an uplink channel. Each of the user equipment 100_1, 100_2, and 100_3 and the base station 900 may correspond to a first device that receives a pilot signal or a second device that transmits a pilot signal.

In some implementations, a wireless communication network between the plurality of user equipment 100_1, 100_2, and 100_3 and the base station 900 may support communication for multiple users by sharing available network resources. For example, in a wireless communication network, information may be transmitted using different methods such as code division multiple access (CDMA), frequency division multiple access (FDMA), time division multiple access (TDMA), orthogonal frequency division multiple access (OFDMA), and single carrier frequency division multiple access (SC-FDMA).

In some implementations, the base station 900 may transmit a downlink signal (DLS) including data to the plurality of user equipment 100_1, 100_2, and 100_3 via at least one antenna port. For example, the base station 900 may precode data signals (or data symbols) and pilot signals (or pilot symbols) and transmit the precoded data signals and pilot signals to the plurality of user equipment 100_1, 100_2, and 100_3 through a downlink channel.

The pilot signal, which is a signal used to estimate a channel of a data signal, may be referred to as a reference signal. For example, the pilot signal may include a demodulation reference signal (DMRS), a common reference signal (CRS), a channel state information reference signal (CSI-RS), a positioning reference signal, and the like. A reference signal may also include various types of signals that are used for channel estimation other than the aforementioned signals, and is not limited to the above-described signals.

The plurality of user equipment 100_1, 100_2, and 100_3 may generate channel state information by estimating a channel using a pilot signal transmitted from the base station 900, and the generated channel state information may include high-dimensional data. Accordingly, the user equipment 100_1, 100_2, and 100_3 may convert channel state information into a compressed form to increase transmission efficiency when transmitting a feedback signal to the base station 900. As described below with reference to the drawings, the user equipment 100_1, 100_2, and 100_3 may compress channel information based on similarity between signals received via antenna ports, and computational load and/or power consumption may be reduced as a result.

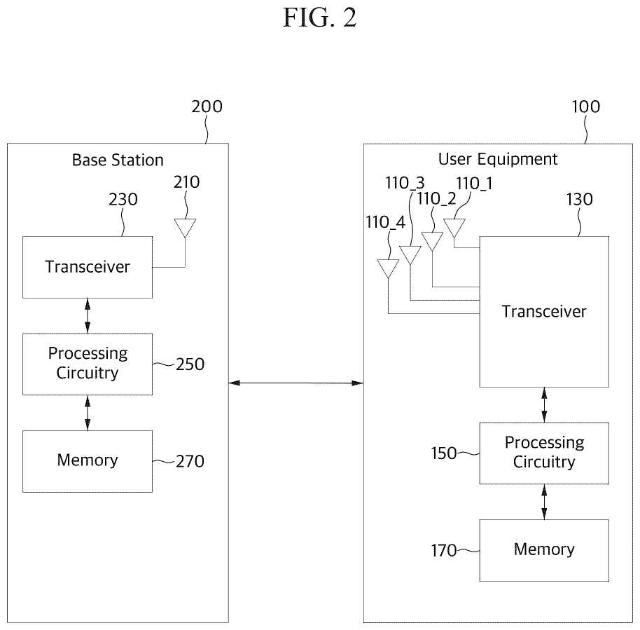

FIG. 2 illustrates an example wireless communication system including a first device 100 and a second device 200. The first device 100 may refer to a device receiving a pilot signal, such as user equipment, and the second device 200 may refer to a device transmitting the pilot signal, such as a base station.

Referring to FIG. 2, the first device 100 may include a plurality of antennas 110_1, 110_2, 110_3, and 110_4, a transceiver 130, processing circuitry 150, and a memory 170. In some implementations, the plurality of antennas 110_1, 110_2, 110_3, and 110_4, the transceiver 130, the processing circuitry 150, and the memory 170 may be included in a single package or may be respectively included in different packages. Although the first device 100 is described as having four antennas 110_1, 110_2, 110_3, and 110_4 in the present disclosure for explanatory convenience, the first device 100 may include more or fewer number of antennas.

In some implementations, the second device 200 may include an antenna 210, a transceiver 230, processing circuitry 250, and a memory 270. Although the base station 900 is described as having a single antenna 210 in the present disclosure for explanatory convenience, the base station 900 may also include a plurality of antennas similar to those of the first device 100. Hereinafter, redundant descriptions of the first device 100 and the second device 200 will be omitted.

The plurality of antennas 110_1, 110_2, 110_3, and 110_4 may receive a signal from the base station 900 and transmit the signal received to the transceiver 130 and may transmit a signal received from the transceiver 130 to the second device 200. In some implementations, the plurality of antennas 110_1, 110_2, 110_3, and 110_4 may include a phased array for beamforming.

The transceiver 130 may process a signal received from the base station 900 via the plurality of antennas 110_1, 110_2, 110_3, and 110_4, and may provide the processed signal to the processing circuitry 150. In addition, the transceiver 130 may process a signal provided by the processing circuitry 150, and may output the processed signal through the plurality of antennas 110_1, 110_2, 110_3, and 110_4. In some implementations, the transceiver 130 may include an analog circuit such as a low-noise amplifier, mixer, filter, power amplifier, and oscillator. In some implementations, the transceiver 130 may process a signal received via the plurality of antennas 110_1, 110_2, 110_3, and 110_4 and/or a signal received from the processing circuitry 150 under the control of the processing circuitry 150.

The processing circuitry 150 may extract and/or process information transmitted by the second device 200 by processing a signal received from the transceiver 130. For example, the processing circuitry 150 may extract information by demodulating and/or decoding the signal received from the transceiver 130. In addition, a signal including information to be transmitted to the base station 900 may be generated and provided to the transceiver 130. The processing circuitry 150 may provide a signal generated by encoding and/or demodulating data to be transmitted to the second device 200 to the transceiver 130. For example, the processing circuitry 150 may encode a pilot signal received from the second device 200 into compressed channel information (or channel state information) using a trained model.

In some implementations, the processing circuitry 150 may include a programmable component such as a central processing unit (CPU) and a digital signal processor (DSP) or a reconfigurable component such as a field programmable gate array (FPGA), or may also include a component providing a fixed function such as intellectual property (IP) core. In some implementations, the processing circuitry 150 may include a memory for storing data and/or a series of instructions or may access to an external memory, such as the memory 170.

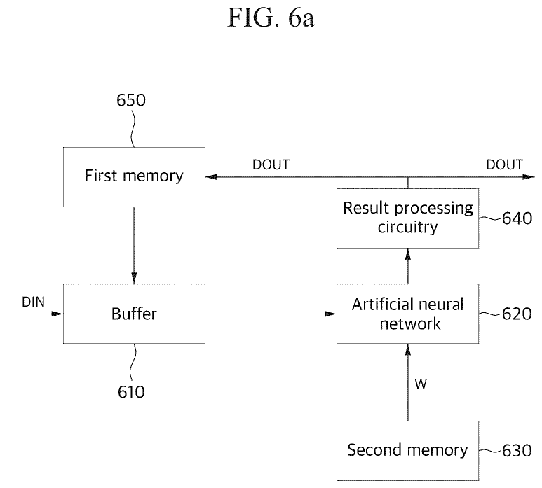

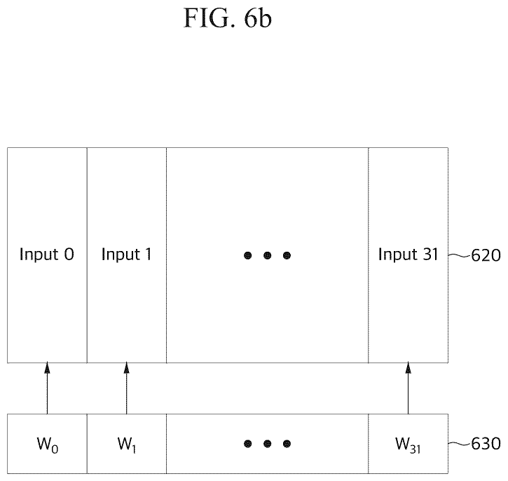

The memory 170 may be accessed by the processing circuitry 150 of the first device 100 and may store various types of data. The data may include software (e.g., a program) and/or input and output data for execution of the software. For example, the memory 170 may store data for generating or compressing channel estimation information, or may store data for compressing channel information corresponding to each of the plurality of antennas 110_1, 110_2, 110_3, and 110_4. More specifically, the memory 170 may store information on weights and/or output result of each layer of an artificial neural network model which will be described below with reference to FIGS. 6A and 6B. In addition, the memory 170 may include a volatile memory (e.g., a dynamic random-access memory (DRAM) or a static random-access memory (SRAM)) and/or a non-volatile memory (e.g., a flash memory) to store data.

In the present specification, operations performed by the transceiver 130 and/or the processing circuitry 150 may be simply referred to as operations performed by the first device 100. Accordingly, operations performed by the first device 100 may be performed by the transceiver and/or the processing circuitry included in the first device 100, and operations performed by the second device 200 may be performed by the transceiver and/or the processing circuitry included in the second device 200.

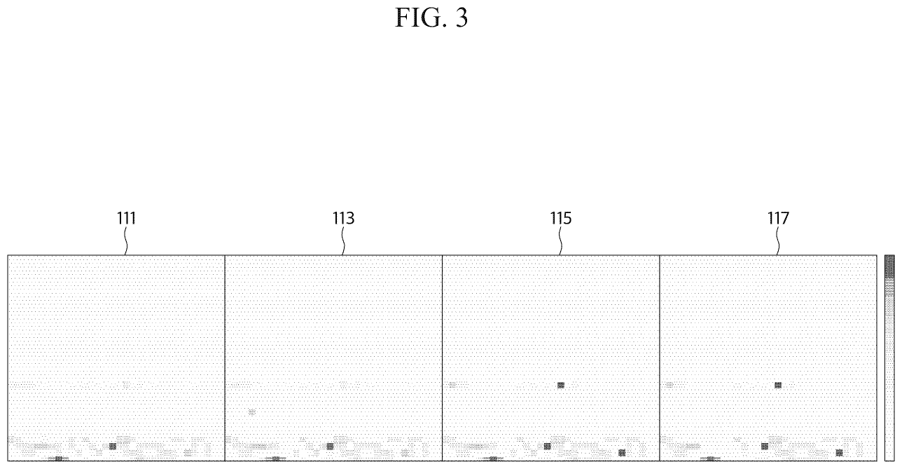

FIG. 3 is a diagram illustrating examples of channel estimation information. For example, FIG. 3 is a diagram of an example of a heat map illustrating channel estimates corresponding to each of the four antennas on a two-dimensional time-delay plane. In the heat map, the horizontal axis represents a sequential time index, such as an orthogonal frequency division multiplexing (OFDM) symbol, slot, or frame, estimated using a pilot signal, and the vertical axis represents a subcarrier index in case a delay tab of a channel impulse response (CIR) or a channel frequency response (CFR) is used. In the graph, the gray level (i.e., the intensity in black-and-white) of each pixel is represented proportional to an amplitude or power of a channel coefficient measured at a given time and delay (or subcarrier) combination.

Referring to FIG. 3, the antennas may receive a pilot signal. More specifically, the first device 100 (or user equipment) may receive the same pilot signal transmitted through a downlink channel via each of a plurality of antennas through a spatially different path. A channel impulse response estimated for each antenna may be represented as a first heat map 111, a second heat map 112, a third heat map 113, and a fourth heat map 114, corresponding to each of the four antennas respectively.

As shown in FIG. 3, the first heat map 111, the second heat map 112, the third heat map 113, and the fourth heat map 114 may each display a result of MIMO channel estimation performed based on the same pilot signal, and may exhibit similar patterns. Heat maps exhibiting similar patterns may indicate that channel information between the antennas is similar.

In some implementations, the wireless communication method may compress channel information based on a difference between channel information corresponding to the antennas. For example, compressed channel information may be generated by providing a difference between channel information corresponding to a reference antenna and channel information corresponding to another antenna among the plurality of antennas to the trained model. Accordingly, not only may the amount of data transmitted to the second device 200 (or a base station) be reduced, but power consumption may also be reduced by decreasing the resources required to compress the channel information.

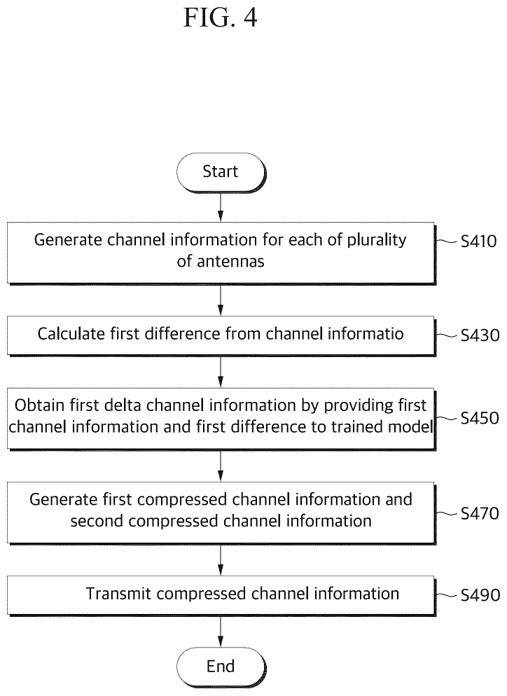

FIG. 4 is a flowchart illustrating an example of a wireless communication method. For example, FIG. 4 shows how the first device 100 of FIG. 2 operates. As shown in FIG. 4, the operating method of the first device 100 may include operations S410, S430, S450, S470, and S490. Hereinafter, FIG. 4 will be described with reference to FIG. 2.

Referring to FIG. 4, in operation S410, the first device 100 may generate channel information for each of the plurality of antennas. For example, when the first device 100 receives pilot signals from the second device 200 via the plurality of antennas, the first device 100 may generate channel information by estimating a channel for each antenna using a channel impulse response and/or channel frequency response. For example, the first device 100 may include the first antenna 110_1, the second antenna 110_2, the third antenna 110_3, and the fourth antenna 110_4, and may generate first channel information, second channel information, third channel information, and fourth channel information estimated corresponding to the first antenna 110_1, the second antenna 110_2, the third antenna 110_3, and the fourth antenna 110_4, respectively. Here, the first channel information, the second channel information, the third channel information, and the fourth channel information may be represented by vectors, \vec{X}₁, \vec{X}₂, \vec{X}₃, and \vec{X}₄, respectively.

In operation S430, the first device 100 may calculate a first difference from the channel information. For example, the first device 100 may calculate the first difference between the first channel information corresponding to the first antenna 110_1 and the second channel information corresponding to the second antenna 110_2. In addition, the first device 100 may calculate differences between channel information of other antennas, such as between channel information of the third antenna 110_3 and the fourth antenna 110_4, based on the first channel information.

Since the first channel information and the second channel information are similar, as described above with reference to FIG. 3, the first difference between the first channel information and the second channel information, which is in vector form, may be a vector including multiple zeros. Here, the first difference may be represented as a vector such as Δ\vec{X}₂, and differences corresponding to the third channel information and the fourth channel information may be represented as vectors Δ\vec{X}₃ and Δ\vec{X}₄, respectively.

In operation S450, the first device 100 may obtain first delta channel information by providing the first channel information and the first difference to the trained model. The trained model may refer to any model that is trained using sample data. For example, the trained model may include an artificial neural network including a convolutional neural network (CNN) and a transformer.

The CNN may be used to extract a spatial feature from two-dimensional input data such as an image, and may capture a local pattern of the input data by including a convolutional layer and a pooling layer. The CNN may extract features of the input data through local computation using a filter, and may learn higher-level representations by hierarchically combining these features. In particular, the CNN may be effectively used for compression and restoration of channel information in a wireless communication system, as a spatial correlation of the channel information may be taken into account.

The transformer may be an artificial neural network designed to learn global relationships within input data based on a self-attention mechanism. The transformer may learn dependencies between different time steps or spatial elements in parallel through multi-head self-attention computation.

In some implementations, the trained model may have a hybrid structure in which the CNN and transformer are combined, and more specifically, the trained model may be implemented as a spatially separable attention transformer network (STNet). An encoder of the STNet, which includes a CNN layer and a spatially separable attention transformer block (STB), may compress high-dimensional channel information into a low-dimensional code. In particular, the transformer block of the STNet may effectively model a long-term correlation between antennas while reducing computational complexity by combining locally grouped self-attention (LSA) with global sub-sampled attention (GSA). A process of generating first delta information using the trained model will be described below with reference to FIGS. 6A and 6B.

In some implementations, input data to the trained model may include a second difference between the first channel information and the third channel information corresponding to the third antenna among the plurality of antennas. In addition, second delta channel information corresponding to the third channel information may be obtained based on a first layer among the plurality of layers and the number of active antennas among the plurality of antennas. Here, the first device 100 may obtain the second delta channel information corresponding to the third channel information from the trained model using a weight corresponding to the second channel information which is a previous channel, based on whether first device 100 operates in the first layer, which is a predetermined layer, and the number of active antennas among the plurality of antennas. In other words, the first device 100 may reduce overhead by using a weight or a difference information value used for difference information corresponding to a previous antenna. Here, the number of active antennas within the first device 100 may be determined by the first device 100. Additionally, the first device 100 may generate third compressed channel information corresponding to the third antenna based on first compressed channel information and the second delta channel information.

In operation S470, the first device 100 may generate second compressed channel information. For example, the first device 100 may generate first compressed channel information, and may generate second compressed channel information corresponding to the second channel information based on the first compressed channel information corresponding to the first channel information and the first delta channel information.

As an example, when the first compressed channel information is represented as \vec{Y}₁ and the first delta channel information corresponding to the first difference Δ\vec{X}₂ is represented as Δ\vec{Y}₂, the first delta channel information Δ\vec{Y}₂ output by the trained model may be compressed channel information in which information as much as the first compressed channel information \vec{Y}₁, which is used as a reference, is excluded, since the first difference Δ\vec{X}₂ provided to the trained model corresponds to a difference between channels. Accordingly, as shown in Equation 1 below, the first device 100 may generate second compressed channel information \vec{Y}₂ by adding the first compressed channel information \vec{Y}₁ to the first delta channel information Δ\vec{Y}₂.

\vec{Y}₂=Δ\vec{Y}₂+\vec{Y}₁ Equation 1

Likewise, as shown in Equation 2 below, the first device 100 may generate third compressed channel information \vec{Y}₃ by adding the first compressed channel information \vec{Y}₁ to the second delta channel information Δ\vec{Y}₃, and generate fourth compressed channel information \vec{Y}₄ by adding the first compressed channel information \vec{Y}₁ to third delta channel information Δ\vec{Y}₄.

\vec{Y}₃=Δ\vec{Y}₃+\vec{Y}₁ Equation 2

\vec{Y}₄=Δ\vec{Y}₄+\vec{Y}₁

In operation S490, the first device 100 may transmit compressed channel information. For example, the compressed channel information may include the first compressed channel information and the second compressed channel information, and the first device 100 may transmit the compressed channel information to the second device 200.

Here, the compressed channel information may be compressed channel state information. The channel state information may include a plurality of indicators generated based on a result of channel estimation, such as, a channel quality indicator (CQI), a pre-coding matrix indicator (PMI), and a rank indicator (RI). The channel state information may be utilized by the second device 200 to control wireless resources such as link adaptation, scheduling, and beamforming and may be transmitted periodically, semi-periodically, or aperiodically. When the channel state information is transmitted to the second device 200 aperiodically, the first device 100 may transmit the channel state information as a feedback signal including channel state information based on downlink control information (DCI) received from the second device 200.

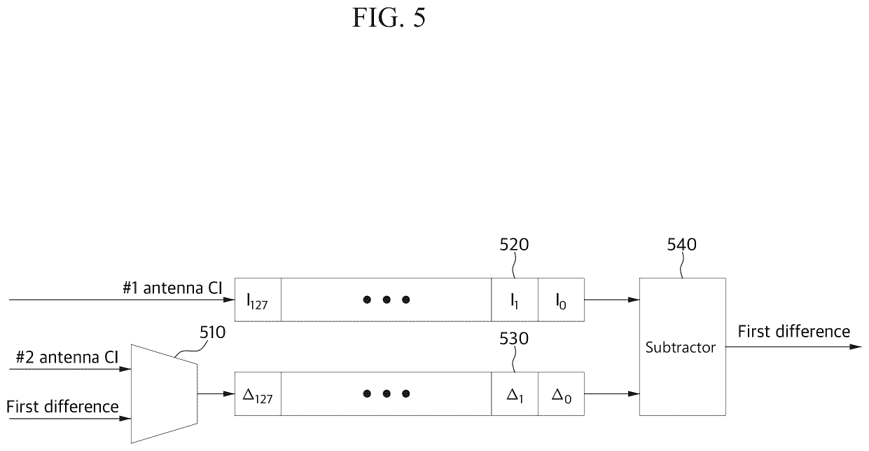

FIG. 5 is a diagram illustrating an example method of preprocessing channel information. As described above with reference to FIG. 4, the trained model may be used to compress channel information, and input data in which the channel information is preprocessed may be provided to the trained model.

Referring to FIG. 5, a first vector 520 may include a plurality of blocks created by dividing first channel information #1 antenna CI which is estimated from the first antenna. Here, the first channel information #1 antenna CI may be a channel response value estimated based on a channel impulse response or a channel frequency response. The first vector 520 may include total 2048 channel information values, and each channel information value may be represented as a real component or a complex component. The length of the vector, 2048, may be designed to include a channel estimation result for each antenna or subcarrier in a multiple antenna system or a multi-subcarrier-based wireless communication system. The first vector 520 may be divided into 128 blocks to process input of the artificial neural network. Here, a first block I₀ may include 16 channel information values.

In some implementations, a second vector 530 may be a vector including output values selected via a multiplexer 510. The multiplexer 510 may select and output one of channel information estimated from the second antenna and a first difference corresponding to the second channel output from a previous layer of the artificial neural network. The second vector 530 may have the same structure as that of the first vector 520 and include 128 blocks from Δ₀ to Δ₁₂₇, and each block may include 16 channel information values corresponding to the channel information.

In some implementations, the multiplexer 510 may selectively output one of second channel information #2 antenna CI and the first difference based on a control signal of the artificial neural network. For example, when an input more useful for inference in a particular layer is identified to be the second channel information #2 antenna CI, the multiplexer 510 may select and output the second channel information #2 antenna CI as the second vector 530, and when an input more useful for inference in another layer is identified to be the first difference, the multiplexer 510 may select and output the first difference as the second vector 530.

A subtractor 540 may receive the first vector 520 and the second vector 530 and generate a first difference by calculating a difference between each corresponding element. However, when the first difference calculated via the multiplexer 510 in the previous layer is selected, the subtractor 540 may skip the calculation, and the second vector 530 may be forwarded to the next processing stage without any changes. The first difference then may be used as an input to the artificial neural network.

FIGS. 6A and 6B are diagrams illustrating an example method of processing an input to a trained model. For example, in FIGS. 6A and 6B, the first device 100 of FIG. 2 may include an artificial neural network 620 as an example of the trained model. Hereinafter, FIGS. 6A and 6B will be described with reference to FIG. 2.

Referring to FIGS. 6A and 6B, a buffer 610 may receive a difference input DIN and store the difference input DIN temporarily. The difference input DIN may include a first difference which is a difference between the first channel information and the second channel information. The difference input DIN stored in the buffer 610 may be provided to the artificial neural network 620.

In some implementations, the artificial neural network 620, as a computational block including a plurality of calculating units, may extract a high-dimensional feature based on input data and output a compressed result. As described above, the artificial neural network 620 may include a CNN, transformer, or STNet. The artificial neural network 620 may include a plurality of processing elements (PEs) and perform parallel calculating using the PEs.

In some implementations, a second memory 630 may store weights. The second memory 630 may load weights, and may include SRAM, for example. As described below with reference to FIG. 6B, loading of the weights from the second memory 630 may be skipped based on the difference input DIN input to the artificial neural network 620.

A calculation result of the artificial neural network 620 may be transmitted to a result processing circuitry 640. The result processing circuitry 640 may preprocess an output value of the artificial neural network 620 and may include an activation function including a dot product operation, an accumulator, and the like.

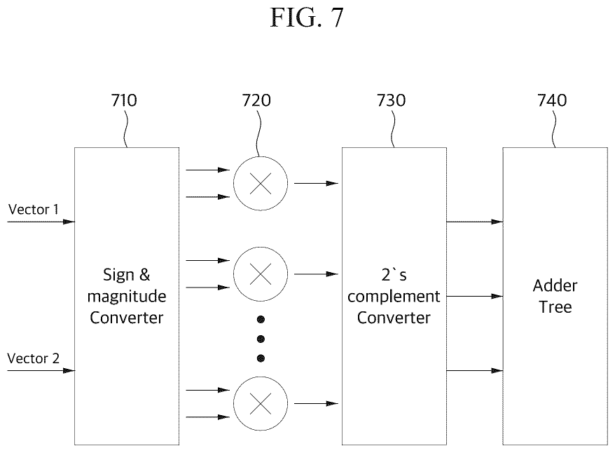

The dot product operation calculates the inner product between two vectors and may refer to accumulation of products between each element. Detailed structure and operation of the dot product operation in the result processing circuitry 640 will be described below with reference to FIG. 7.

In some implementations, a difference result DOUT output from the result processing circuitry 640 may include delta channel information. Here, when the first difference corresponding to the second antenna is input as the difference input DIN, the delta channel information may include the first delta channel information \vec{Y}₂. The delta channel information may be preprocessed and/or be stored in a first memory 650. The preprocessing process of the delta channel information may refer to an operation of adding the first compressed channel information \vec{Y}₁ to the delta channel information.

In some implementations, the first memory 650 may include SRAM. The first memory 650 may selectively provide the difference result DOUT as an input to the next layer after determining whether to reuse the difference result DOUT by comparing it with a previous input value or output value. For example, the delta channel information stored in the first memory 650 may be provided again as an input to the artificial neural network 620, or a previous input value may be used as an input to the next layer by bypassing an input buffer. In other words, a plurality of pieces of compressed channel information generated in the first layer among the plurality of layers may be used as input information of a second layer among the plurality of layers or iterate in the plurality of layers when a previous difference input DIN is used as input information.

Referring to FIG. 6B, the artificial neural network 620 may include a plurality of input blocks, and each input block may perform calculation of the artificial neural network 620 using a corresponding input value and a weight. Here, the input value may refer to the difference input DIN. For example, 32 input values from Input 0 to Input 31 may be provided to the artificial neural network 620, and each input value may represent a value indicating channel information or channel difference.

The second memory 630 may store a plurality of weights from W₀ to W₃₁ used for calculations in the artificial neural network 620 and sequentially load and provide each weight to the artificial neural network 620 based on a corresponding input value. For example, the artificial neural network 620 may load Input 0 and W₀ which corresponds to the Input 0 from the second memory 630 and use them for calculation. Similarly, the artificial neural network 620 may load Input 1 and W₁ which corresponds to the Input 1 from the second memory 630 and use them for calculation.

The input values may be a plurality of values configured to have a predefined bit (e.g., 8 bits), and may be provided to the artificial neural network 620 in parallel. For example, when 32 input values are input simultaneously and each input value performs a multiplication operation with 16 weights, 512 weights may be sequentially loaded from the second memory 630. The loading of the weights may be carried out by transmitting 16 weights per cycle, and this this case, a total of 32 cycles may be required to load all the weights of the artificial neural network 620.

When an input value is identified as 0, because a weight corresponding to the input value will not be used for calculation even when the weight is loaded from the second memory 630, the process of loading the weight corresponding to the input value from the second memory 630 to the artificial neural network 620 may be skipped. That is, the first device 100 may determine whether the value of the first difference is 0, and when the first difference value is identified as 0, the first device 100 may skip retrieving weight data from the second memory 630. For example, when Input 1 is 0, a process of loading W₁ from the second memory 630 may be skipped.

In some implementations, the first device 100 may skip the process of loading a weight as a difference value of channel information of the plurality of antennas using MIMO is provided to the trained model as an input. In addition, non-zero difference values may be represented using the minimal number of bits as they are relatively small values. Therefore, skipping the loading of weights may reduce unnecessary access to the second memory 630, thereby reducing the total computational load and power consumption.

FIG. 7 is a diagram illustrating an example method of performing a dot product operation. For example, the diagram may illustrate a process of a dot product operation used in an activation function or an accumulation operation performed by the result processing circuitry 640 of FIG. 6A.

Referring to FIG. 7, a first vector and a second vector may be provided as inputs to a sign-and-magnitude converter 710 that performs conversion of sign and magnitude before feeding them into a multiplier 720. Each element of the first vector and the second vector may go through sign-and-magnitude conversion in the sign-and-magnitude converter 710. For example, during the sign-and-magnitude conversion, 1 may be converted into 0001, and −1 may be converted into 1001. Since sign-and-magnitude conversion uses the most significant bit (MSB) as a sign bit, and a change in total bits, including bits indicating magnitudes of the remaining bits, is limited even when a sign of a represented value changes, the number of bit toggles may be reduced.

When sign and magnitude of the first vector and the second vector is converted by the sign-and-magnitude converter 710, a multiplication operation may be performed on corresponding elements by the multiplier 720. A result of the multiplication operation may be provided to a 2's complement converter 730.

For example, when an output of the multiplier 570 is −5, a negative number, −5 may be represented as 1101 in 4-bit sign-and-magnitude representation, and a method of converting −5 into 2's complement format may include a process of reversing lower bits 1010 into 1010 except the sign bit and adding 1 to make 1011. The converted value may be accumulated with other results from the 2's complement converter 730 in an adder tree 740. when sign-and-magnitude representation is used in the adder tree 740, the number of bit toggles may increase since operations such as sign comparison and subtraction may need to be performed when the signs differ during calculation. For this reason, an output value of the multiplier 720 may be converted into 2's complement format before input to the adder tree 740.

An output value of the adder tree 740 may be generated in 2's complement format, further converted into a differential encoding-based number by the result processing circuitry 640 of FIG. 6A, and converted back into sign-and-magnitude format from the differential encoding-based number.

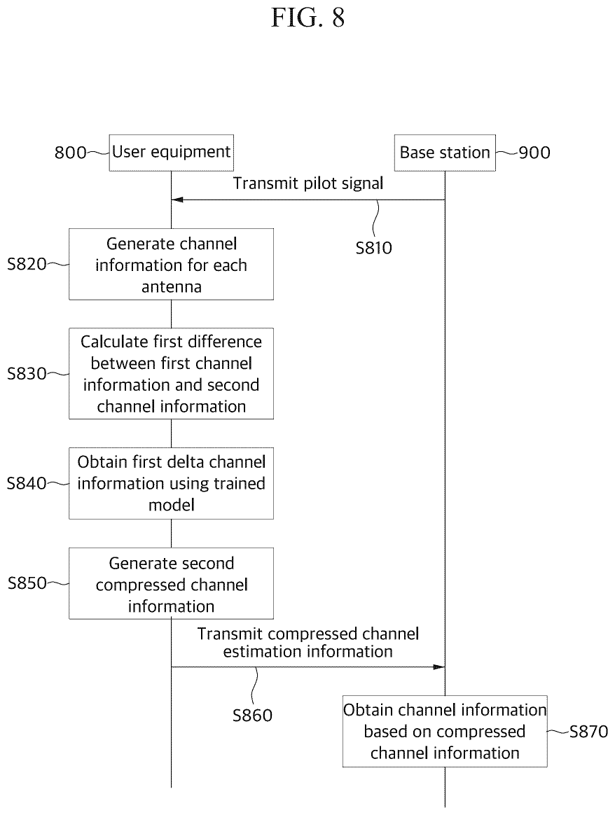

FIG. 8 is a diagram illustrating an example method of operating user equipment 800 and a base station 900. For example, the user equipment 800 and the base station 900 may correspond to the first device 100 and the second device 200 of FIG. 2, respectively. Hereinafter, FIG. 8 will be described with reference to FIG. 2.

Referring to FIG. 8, in operation S810, the base station 900 may transmit a pilot signal to the user equipment 800. For example, the pilot signal may be at least one of a CSI-RS, DMRS, or PRS, and may be assigned and transmitted across a plurality of subcarriers and a plurality of time slots.

In operation S820, the user equipment 800 may generate channel information for each antenna. For example, the user equipment 800 may include a plurality of antennas, and estimate first channel information corresponding to a first antenna among the plurality of antennas and second channel information corresponding to a second antenna among the plurality of antennas, based on the pilot signal received from the base station 900. In addition, the user equipment 800 may generate channel information corresponding to each antenna as a complex number vector or a real number vector. Here, the channel information may be a channel impulse response or a frequency domain channel response.

In operation S830, the user equipment 800 may calculate a first difference between the first channel information and the second channel information. For example, the first difference may be calculated between the first channel information corresponding to the first antenna among the plurality of antennas and the second channel information corresponding to the second antenna among the plurality of antennas. In addition, the user equipment 800 may calculate differences between channel information of other antennas based on the first channel information.

In operation S840, the user equipment 800 may obtain first delta channel information using the trained model. For example, the trained model may include CNN and transformer.

In operation S850, the user equipment 800 may generate second compressed channel information. For example, the user equipment 800 may generate the second compressed channel information corresponding to the second channel information based on first compressed channel information corresponding to the first channel information and the first delta channel information.

In operation S860, the user equipment 800 may transmit compressed channel estimation information. For example, the compressed channel information may include the first compressed channel information and the second compressed channel information, and the user equipment 800 may transmit the compressed channel information to the base station 900 in periodic, semi-periodic, or aperiodic manner.

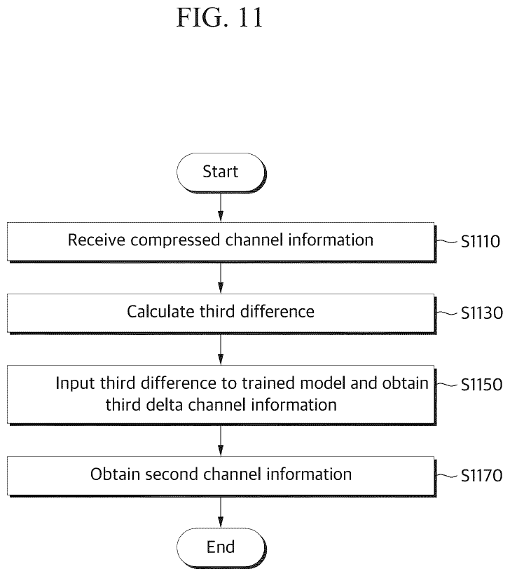

In operation S870, the base station 900 may obtain channel information based on the compressed channel information received. For example, the base station 900 may estimate channel information by using an artificial neural network that estimates channel information from compressed channel information without preprocessing the received compressed channel estimation information. Alternatively, the base station 900 may infer second channel information by inputting the first compressed channel information included in the compressed channel information and a difference between the first compressed channel information and the second compressed channel information. A method of inferring second channel information using the first compressed channel information and a difference between the first compressed channel information and the second compressed channel information will be described below with reference to FIG. 11.

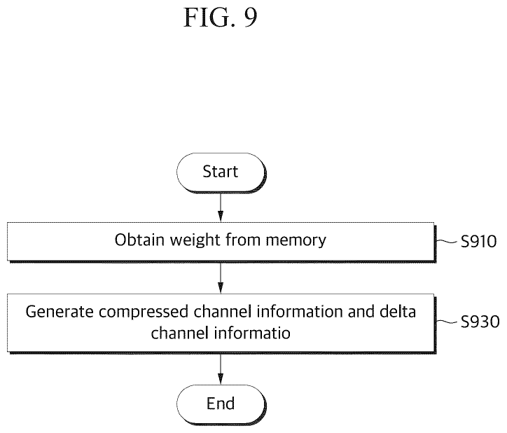

FIG. 9 is a flowchart illustrating an example of a wireless communication method. For example, FIG. 9 is a flowchart illustrating how the first device 100 of FIG. 2 operates. Operations S910 and S930 of FIG. 9 may be included in operation S450 of FIG. 4. Hereinafter, FIG. 9 will be described with reference to FIG. 2.

Referring to FIG. 9, in operation S910, the first device 100 may obtain a weight from the memory. For example, the first device 100 may load a plurality of weights from the memory (e.g., SRAM) to perform an inference operation in the artificial neural network. The memory may store a pre-trained model parameter and a plurality of weights. The first device 100 may selectively load only weights required based on a first difference value input.

In operation S910, the first device 100 may generate compressed channel information and delta channel information. For example, the first device 100 may provide a first difference value as an input to the artificial neural network and obtain corresponding delta channel information as an output. The delta channel information may be represented as a vector represented by compressing the first difference between the first channel information of the first antenna and the second channel information of the second antenna. The first device 100 may generate second compressed channel information by adding the first channel information to the delta channel information which is the output of the artificial neural network. Here, the second compressed channel information generated may be processed into a form suitable for transmission after being quantized or preprocessed.

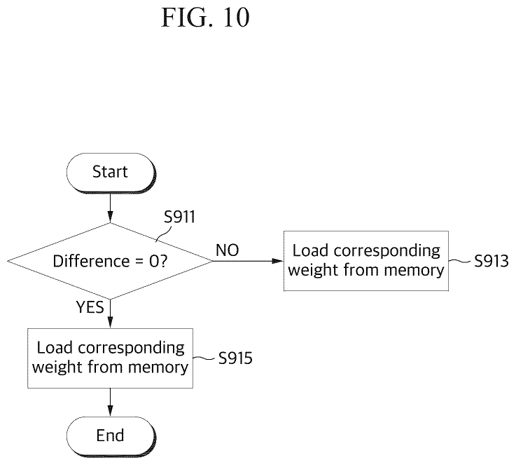

FIG. 10 is a flowchart illustrating an example of a wireless communication method. For example, FIG. 10 is a flowchart illustrating how the first device 100 of FIG. 2 operates. Operation S911, S913, and S915 of FIG. 10 may be included in operation S910 of FIG. 9, or be executed by the first device 100 of FIG. 2. Hereinafter, FIG. 10 will be described with reference to FIG. 2.

Referring to FIG. 10, in operation S911, the first device 100 may identify whether the first difference is 0. For example, the first difference may indicate a difference between first channel information estimated from the first antenna and second channel information estimated from the second antenna, and, due to characteristics of MIMO, most of the differences between estimated channel information for each antenna may be 0. Accordingly, in most cases, the first device 100 may determine that the difference is 0.

When the first device 100 determines that the difference is not 0 (when the answer to operation S911 is NO), in operation S913, the first device 100 may load a weight corresponding to the difference from the memory for calculation using the artificial neural network. Then, the first device 100 may generate delta channel information based on the loaded weight and the difference.

When the first device 100 determines that the difference is 0 (when the answer to operation S911 is YES), in operation S915, the first device 100 may skip a process of loading a weight corresponding to the difference from the memory. More specifically, when the difference is identified as 0, since a weight corresponding to the difference will not be used for computation in the artificial neural network even when its loaded form the memory, the first device 100 may skip the process of loading the weight corresponding to the difference from the memory to the artificial neural network.

FIG. 11 is a flowchart illustrating an example of a wireless communication method. For example, FIG. 11 is a flowchart illustrating how the second device 200 of FIG. 2 operates.

In operation S1110, the second device 200 may receive a plurality of pieces of compressed channel information. For example, the second device 200 (e.g., a base station) may receive compressed channel information corresponding to the plurality of antennas of the first device 100 from the first device 100 (e.g., user equipment) through an uplink.

In operation S1130, the second device 200 may calculate a third difference from the compressed channel information. For example, the second device 200 may select second compressed channel information corresponding to the second antenna based on the first compressed channel information corresponding to the first antenna and generate the third difference by calculating a difference between the first compressed channel information and the second compressed channel information. The third difference may indicate a relative difference between compressed representations and may be used as an input for a restoration calculation of the artificial neural network.

In operation S1150, the second device 200 may obtain third delta channel information by inputting the third difference to the trained model. For example, the second device 200 may obtain the third delta channel information corresponding to the second antenna by providing input data including the first compressed channel information and the third difference to a pre-trained artificial neural network (e.g., CNN, transformer, or STNet). The artificial neural network may estimate delta channel information corresponding to the second antenna using an inverse function or a restoration model of a compressing process performed in the first device 100.

In operation S1170, the second device 200 may obtain the second channel information. For example, the second device 200 may restore the second channel information corresponding to the second antenna by combining the first channel information (or reference channel information restored in the second device 200) and the third delta channel information. The final second channel information restored may be utilized in MIMO precoding, scheduling, or link adaptation, for example.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

As described above, example implementations have been disclosed in the drawings and specification. While the example implementations have been described with reference to specific terms, it shall be understood that the terms used herein are only for the purpose of describing the technical spirit of the present disclosure and are not for limiting the scope of the present disclosure as defined in the claims. Therefore, those skilled in the art will appreciate that various modifications and equivalent implementations are possible without departing from the scope of the present disclosure.

What is claimed is:

1. A wireless communication method comprising:
receiving, by a first device, a pilot signal from a second device via a plurality of antennas;
generating, by the first device, channel information by estimating a channel for each antenna of the plurality of antennas based on the pilot signal;
calculating, by the first device, a first difference between first channel information and second channel information, the first channel information corresponding to a first antenna among the plurality of antennas, and the second channel information corresponding to a second antenna among the plurality of antennas;
obtaining, by the first device, first delta channel information by providing input data to a trained model, the input data including the first difference;
generating, by the first device and based on first compressed channel information and the first delta channel information, second compressed channel information, wherein the first compressed channel information corresponds to the first channel information, and the second compressed channel information corresponds to the second channel information; and
transmitting, by the first device, compressed channel information to the second device, the compressed channel information including the first compressed channel information and the second compressed channel information.

2. The method of claim 1, wherein obtaining the first delta channel information comprises:
loading a plurality of weights from a memory; and
generating the first delta channel information based on the plurality of weights and the first difference.

3. The method of claim 2, wherein generating the second compressed channel information comprises adding the first compressed channel information and the first delta channel information.

4. The method of claim 2, wherein generating the first delta channel information comprises at least one of:
performing an accumulation operation on products of the first difference and the plurality of weights; or
applying an activation function to a weighted sum.

5. The method of claim 4, wherein performing the accumulation operation comprises performing a dot product operation on a first input vector and a second input vector, and
wherein performing the dot product operation comprises:
performing a sign-and-magnitude conversion in which the first input vector and the second input vector are separated into a sign bit and a magnitude bit; and
performing a multiplication operation on converted vectors for each corresponding element.

6. The method of claim 5, wherein performing the dot product operation comprises:
converting a result of the multiplication operation into two's complement format; and
cumulatively summing the converted result.

7. The method of claim 2 comprising
determining whether the first difference is 0; and
skipping loading of the plurality of weights when the first difference is 0.

8. The method of claim 2, wherein the trained model comprises a plurality of layers, and
wherein the plurality of layers include an artificial neural network comprising a convolutional neural network (CNN) and a transformer.

9. The method of claim 8, wherein the compressed channel information generated in a first layer among the plurality of layers is configured to be used as input information to a second layer among the plurality of layers, and is configured to be iteratively processed within the plurality of layers.

10. The method of claim 8, wherein the input data comprises a second difference between the first channel information and third channel information, the third channel information corresponding to a third antenna among the plurality of antennas, and
wherein the method comprises:
obtaining a second weight from a first weight based on a first layer among the plurality of layers or a number of active antennas among the plurality of antennas, the second weight corresponding to the second difference, and the first weight corresponding to the first difference;
obtaining second delta channel information based on the first weight, the second delta channel information corresponding to the third channel information; and
generating third compressed channel information based on the first compressed channel information and the second delta channel information, the third compressed channel information corresponding to the third antenna.

11. The method of claim 1, wherein the pilot signal includes at least one of a demodulation-reference signal (DM-RS), a channel state information-reference signal (CSI-RS), or a positioning reference signal (PRS).

12. A first device configured to be in communication with a second device, the first device comprising:
a plurality of antennas;
a transceiver coupled to the plurality of antennas;
a memory; and
a processor,
wherein the processor is configured to:
generate channel information by estimating a channel of each antenna of the plurality of antennas based on a pilot signal, the pilot signal being received from the second device via the plurality of antennas and the transceiver;
calculate a first difference between first channel information and second channel information, the first channel information corresponding to a first antenna among the plurality of antennas, and the second channel information corresponding to a second antenna among the plurality of antennas;
obtain first delta channel information by providing input data to a trained model, the input data including the first channel information and the first difference;
generate second compressed channel information based on first compressed channel information and the first delta channel information, the second compressed channel information corresponding to the second channel information, and the first compressed channel information corresponding to the first channel information; and
transmit compressed channel information to the second device via the transceiver, the compressed channel information including the first compressed channel information and the second compressed channel information.

13. The first device of claim 12, wherein the processor is configured to:
load a plurality of weights from the memory; and
generate the first delta channel information based on the plurality of weights, the first channel information, and the first difference.

14. The first device of claim 13, wherein the processor is configured to add the first compressed channel information to the first delta channel information.

15. The first device of claim 13, wherein the processor is configured to perform an accumulation operation on products of the first difference and the plurality of weights.

16. The first device of claim 15, wherein performing the accumulation operation comprises performing a dot product operation on a first input vector and a second input vector, and
wherein the processor is configured to:
perform a sign-and-magnitude conversion in which the first input vector and the second input vector are separated into a sign bit and a magnitude bit; and
perform a multiplication operation on converted vectors for each corresponding element.

17. The first device of claim 13, wherein the processor is configured to:
determine whether the first difference is 0; and
skip loading of the plurality of weights when the first difference is 0.

18. The first device of claim 13, wherein the trained model includes a plurality of layers, and
wherein the plurality of layers include an artificial neural network comprising a convolutional neural network (CNN) and a transformer.

19. The first device of claim 18, wherein the input data comprises a second difference between the first channel information and third channel information, the third channel information corresponding to a third antenna among the plurality of antennas, and
wherein the processor is configured to:
obtain a second weight from a first weight based on a first layer among the plurality of layers or a number of active antennas among the plurality of antennas, the second weight corresponding to the second difference, and the first weight corresponding to the first difference;
obtain second delta channel information based on the first weight, the second delta channel information corresponding to the third channel information; and
generate third compressed channel information based on the first compressed channel information and the second delta channel information, the third compressed channel information corresponding to the third antenna.

20. A method for wireless communication between a first device and a second device, the method comprising:
receiving, by the second device, compressed channel information from the first device, the first device including a plurality of antennas;
calculating, by the second device, a first difference between first compressed channel information and second compressed channel information, the first compressed channel information corresponding to a first antenna among the plurality of antennas, and the second compressed channel information corresponding to a second antenna among the plurality of antennas;
obtaining, by the second device, third delta channel information by providing input data and the first difference to a trained model, the third delta channel information corresponding to the second compressed channel information, and the input data including the first compressed channel information; and
generating, by the second device, second channel information based on first channel information and the third delta channel information, the second channel information corresponding to the second antenna, and the first channel information corresponding to the first antenna.
